(19) United States
(12) Patent Application Publication
(10) Pub. No.: US 2005/0000825 A1
(43) Pub. Date: Jan. 6, 2005

(54) Process for efficient hydrogen production by thermochemical water splitting using iodine and sulfur dioxide

(75) Inventors: Mikihiro Nomura, Ibaraki (JP); Kaoru Onuki, Ibaraki (JP); Seiji Fujiwara, Ibaraki (JP); Hiroyuki Okuda, Ibaraki (JP)

Correspondence Address: BANNER & WITCOFF, 1001 G STREET N W, SUITE 1100, WASHINGTON, DC, 20001, US

(73) Assignee: Japan Atomic Energy Research Institute, Kashiwa-shi (JP)

(21) Appl. No.: 10/782,934

(22) Filed: Feb. 23, 2004

(30) Foreign Application Priority Data
Jul. 4, 2003 (JP) 2003-271049

(51) Int. Cl. C25B 1/02

(52) U.S. Cl. 205/637

(57) ABSTRACT

In the IS process, the reaction between sulfur and water is performed on the positive electrode side of a cation exchange membrane and the iodine-involving reaction is on the negative electrode side, so that the subsequent separating operation is eliminated to reduce the amounts of recycling iodine and water.

### BACKGROUND OF THE INVENTION

This invention relates to an improvement of a process (IS process) for hydrogen production by the intense thermal energy from thermochemical water splitting using iodine and sulfur dioxide. The steps of reacting the two acids obtained in the process (i.e. hydroiodic acid and sulfuric acid), separating and concentrating them are combined in a membrane reactor such that sulfuric acid and hydrogen iodide which are obtained as the desired intermediate products are concentrated to reduce the amounts of recycling iodine and water.

The invention particularly relates to a technique by which the aqueous solutions of hydrogen iodide and sulfuric acid that are obtained in high concentrations in the method can be effectively separated using electrode portions and a cation exchange membrane.

While a lot of methods have been proposed for producing hydrogen by using intense thermal energy and water rather than fossil fuels, most have been abandoned for various reasons including low reactivity and the only strategies under current review are the UT-3 cycle and the IS process. The IS process is characterized by an improvement of that part of the Norman et al. process (see Gas Research Institute, GRI-80/0105 (1981)) in which an aqueous solution of hydrogen iodide is separated to produce hydrogen.

In Gas Research Institute, GRI-80/0105 (1981), Norman et al. presented an elementary technique for obtaining hydrogen by thermochemical water splitting using iodine and sulfur dioxide. By the IS process, hydrogen could actually be obtained as reported in Kagaku Kogaku Ronbunshu, vol. 24, no. 2, p. 352-355 (1998) [in Japanese].

An outline of the IS process is shown in FIG. 1. The IS process starts with adding sulfur dioxide (SO₂) and iodine (I₂) to water (H₂O), thereby preparing an aqueous solution containing sulfuric acid (H₂SO₄) and hydrogen iodide (2HI) according to the equation 2H₂O+SO₂+I₂=2HI+H₂SO₄ (this reaction is hereunder referred to as the Bunsen reaction). In Gas Research Institute, GRI-80/0105 (1981) and Kagaku Kogaku Ronbunshu, vol. 24, no. 2, p. 352-355 (1998) [in Japanese], in order to enhance the reaction toward sulfuric acid and hydrogen iodide and separate them, water and iodine are added in excess amounts in the Bunsen reaction, yielding an aqueous solution containing sulfuric acid as a main component and an aqueous solution containing hydrogen iodide and iodine as main components.

FIG. 1 depicts the separation scheme described in Gas Research Institute, GRI-80/0105 (1981). The composition of the aqueous solution containing sulfuric acid as a main component is H₂SO₄+4H₂O and the composition of the aqueous solution containing hydrogen iodide and iodine as main components is 2HI+8I₂+11H₂O. The two aqueous solutions are heated so that the vapors of sulfuric acid (H₂SO₄ or H₂O+SO₃) and hydrogen iodide (2HI) evolve by distillation. By utilizing intense thermal energy, the respective vapors are decomposed to make hydrogen (H₂) and oxygen (0.50₂). The excess amounts of water and iodine and the decomposition products sulfur dioxide and iodine are recycled. The IS process is characterized as being capable of producing hydrogen and oxygen by thermochemical water splitting utilizing intense thermal energy.

As Gas Research Institute, GRI-80/0105 (1981) and Kagaku Kogaku Ronbunshu, vol. 24, no. 2, p. 352-355 (1998) [in Japanese] teach, in the Bunsen reaction in the conventional IS process, water and iodine are added in excess amounts to enhance the reaction while, at the same time, liquid-liquid separation is effected to obtain two phases, one being an aqueous solution of sulfuric acid and the other being an aqueous solution of hydrogen iodide which also contains iodine. FIG. 1 shows the separated solutions of the highest concentration that are obtained in Gas Research Institute, GRI-80/0105 (1981). The composition of the aqueous solution of sulfuric acid is H₂SO₄+4H₂O and the composition of the aqueous solution of hydrogen iodide which also contains iodine is 2HI+8I₂+11H₂O. The separated aqueous solution of sulfuric acid is heated and distilled to evolve sulfuric acid or decomposition products of sulfuric acid (H₂SO₄ or H₂O+SO₃), which are then heated to yield oxygen (0.50₂).

The separated aqueous solution of hydrogen iodide which also contains iodine is heated and distilled to make the vapor of hydrogen iodide (2HI), which is decomposed and heated to yield hydrogen (H₂).

The Bunsen reaction is usually carried out with a batch reactor but in Denki Kagaku, vol. 45, no. 3, p. 139-143 (1977) [in Japanese], the use of a cation exchange membrane is proposed for reducing the amounts of the recycling chemical substances.

For efficient operation of the IS process, it is required to reduce the amounts of the recycling chemical substances. In the scheme shown in FIG. 1, in order to obtain 1 mol of hydrogen (2 g), 8 mol of iodine (2030 g) and 16 mol of water (288 g) that are not involved in the Bunsen reaction are recycled. It is the amounts of these recycling chemicals that need to be reduced. The biggest reason for the need to recycle large amounts of iodine and water is that in order to enhance the reaction toward sulfuric acid and hydrogen iodide in the Bunsen reaction and separate the two products, iodine and water are added in more than stoichiometric amounts.

However, no attempts have been made to ensure that the aqueous solution containing sulfuric acid as a main component and the one containing hydrogen iodide as a main component are concentrated to higher concentrations than the values listed in Gas Research Institute, GRI-80/0105 (1981) which are respectively (H₂SO₄+4H₂O) and (2HI+8I₂+11H₂O). The composition shown in Gas Research Institute, GRI-80/0105 (1981) for the aqueous solution containing hydrogen iodide as a main component is approximately equal to the pseudo-azeotrpic composition of hydrogen iodide.

The primary objective of the present invention is to ensure that sulfuric acid and hydrogen iodide as the two acids obtained after the Bunsen reaction have the following respective compositions, H₂SO₄+aH₂O (a<4) and 2HI+bI₂+cH₂O (b<8 and c<11).

As an alternative to the use of a batch reactor which is a common tool for carrying out the Bunsen reaction, Denki Kagaku, vol. 45, no. 3, p. 139-143 (1977) [in Japanese] proposes the use of a cation exchange membrane. The reactor for implementing this proposal is shown schematically in FIG. 2 and comprises three layers, a positive electrode layer, a cation exchange membrane and a negative electrode layer. Sulfur dioxide and water are introduced at the positive electrode, where the reaction for (SO₂+2H₂O=2H⁺+H₂SO₄+2e⁻) is enhanced to give sulfuric acid and protons (2H⁺). Iodine (and a small amount of water) are introduced at the negative electrode layer, where iodide ions (I⁻) are obtained by the electrode reaction at the negative electrode (I₂⁺2e⁻=2I⁻). The protons evolved at the positive electrode permeate the cation exchange membrane to move to the negative electrode where they react with iodide ions to make hydrogen iodide. However, in the example of Denki Kagaku, vol. 45, no. 3, p. 139-143 (1977) [in Japanese] where continuity reaction was carried out, the aqueous solution containing sulfuric acid as a main component had the single composition of (H₂SO₄+4.5H₂O) and the aqueous solution containing hydrogen iodide as a main component had the single composition of (2HI+12I₂+44H₂O); even in comparison to the composition of the aqueous solution of hydrogen iodide which is shown in FIG. 1, both iodine and water contents are greater, and different from the values contemplated by the present invention.

In the Bunsen reaction depending upon the liquid-liquid separation between the aqueous solution of sulfuric acid and the aqueous solution of hydrogen iodide which also contains iodine, it is known that if an attempt is made to ensure that the second aqueous solution is obtained separately at the highest possible concentration, the result is an aqueous solution of hydrogen iodide plus iodine which, as shown in FIG. 3, has a concentration of hydrogen iodide which is close to but not exceeding the pseudo-azeotropic composition. A large amount of heat, therefore, is required in the subsequent process to separate the pure, water-free form of hydrogen iodide from the aqueous solution of hydrogen iodide plus iodine by distillation. In addition, iodine has been input in a more than stoichiometric amount in order to effect liquid-liquid separation of the aqueous solution of hydrogen iodide and its internal circulation in the process requires extra amount of heat. The need for such large amounts of heat is sometimes disadvantageous from a viewpoint of economy.

### SUMMARY OF THE INVENTION

An object, therefore, of the present invention is to provide a process for hydrogen production from sulfur dioxide, iodine and water using unit operations for the Bunsen reaction and separation of the products, by which process an aqueous solution of sulfuric acid and an aqueous solution of hydrogen iodide can be obtained in separated form, the first aqueous solution having high concentrations of sulfuric acid that have been unable to get by liquid-liquid separation and the second aqueous solution having high concentrations of hydrogen iodide in excess of the pseudo-azeotropic composition.

The present invention employs the operating principle proposed in Denki Kagaku, vol. 45, no. 3, p. 139-143 (1977) [in Japanese] and the sulfur-involving reaction and the iodine-involving reaction are performed on opposite sides of a cation exchange membrane, thus reducing the amounts of iodine and water that are conventionally added in excess amounts in the Bunsen reaction.

Briefly, in the present invention, sulfur dioxide (SO₂) and water (H₂O) are reacted on the positive electrode side of the membrane to make sulfuric acid (H₂SO₄) whereas on the negative electrode side, iodide ions (2I⁻) are obtained from iodine (I₂), thus eliminating the need for a separating operation; this and other features contribute to reducing the amounts of iodine (I₂) and water (H₂O) that have heretofore been added in excess amounts and, as a result, the amounts of recyclables are reduced to enable efficient overall operations.

The invention is also characterized in that the interior of the reactor for the Bunsen reaction is partitioned by a cation exchange membrane into a positive electrode portion and a negative electrode portion, with power applied between the two electrode portions such that the reaction of (SO₂+2H₂O=2H⁺+H₂SO₄+2e⁻) proceeds at the positive electrode and the reaction of (I₂+2e⁻=2I⁻) at the negative electrode, whereby a net chemical change which is the same as the already described Bunsen reaction (2H₂O+SO₂+I₂=2HI+H₂SO₄) proceeds through the electrode reactions.

This chemical change is due to the permselectivity of the cation exchange membrane and the protons that are evolved at the positive electrode pass through the cation exchange membrane to move to the negative electrode where they combine with iodide ions to make hydrogen iodide. Since hydrogen iodide is generated at the negative electrode, the aqueous solution of hydrogen iodide which also contains iodine is concentrated to have a higher hydrogen iodide content. Since the separation method does not depend upon phase equilibrium, hydrogen iodide can be concentrated without the constraints of pseudo-azeotropism which is a phenomenon unique to phase equilibrium. Similarly, the aqueous solution of sulfuric acid can be concentrated at the positive electrode.

For efficient hydrogen production by the IS process, sulfuric acid and hydrogen iodide must be obtained in high concentrations in the process of reaction starting with sulfur dioxide, iodine and water. In the present invention, the reaction between sulfur dioxide and water is performed on the positive electrode side of the cation exchange membrane, separately from the iodine-involving reaction which is effected on the negative electrode side. As a result, the subsequent separating operations are eliminated, contributing to reducing the iodine and water inputs.

As another advantage, iodine need not necessarily be added in excess amount as in liquid-liquid separation and yet the aqueous solutions of hydrogen iodide and sulfuric acid can be obtained in separate form and it is also possible to ensure that the first aqueous solution has high concentrations of hydrogen iodide that exceed the pseudo-azeotropic composition. As a result, there can be provided a method of hydrogen production that performs the Bunsen reaction using less heat in the subsequent process than is conventionally required to separate the pure, water-free form of hydrogen iodide from the first aqueous solution by distillation. In liquid-liquid separation, the two aqueous solutions can be obtained in separate form but neither can be concentrated. According to the invention, both solutions can be concentrated, so it is possible to reduce the amount of equipment that is required to perform the subsequent essential step of concentrating aqueous solutions.

### BRIEF DESCRIPTION OF THE DRAWINGS

FIG. 1 is a schematic of the IS process which shows the composition of an aqueous solution of sulfuric acid and that of an aqueous solution of hydrogen iodide which also contains iodine as they are subjected to liquid-liquid separation;

FIG. 2 shows in concept the reactor shown in Proc. 5th World Hydrogen Energy Conf., p. 487-502 (1984), Pargamon Press;

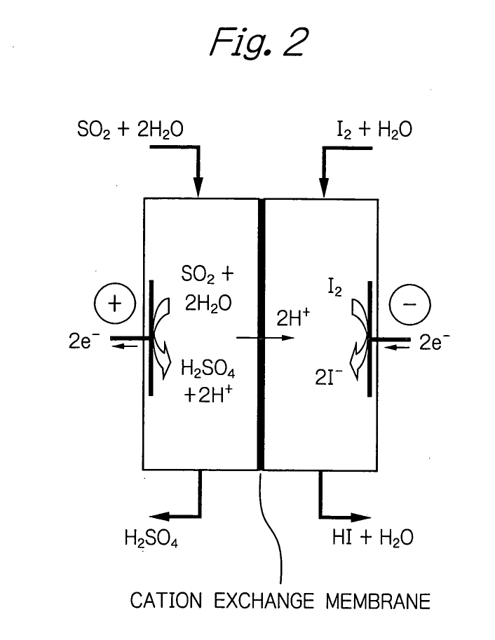

FIG. 3 shows diagrammatically the pseudo-azeotropic composition of an aqueous solution of hydrogen iodide which also contains iodine as it is subjected to liquid-liquid separation;

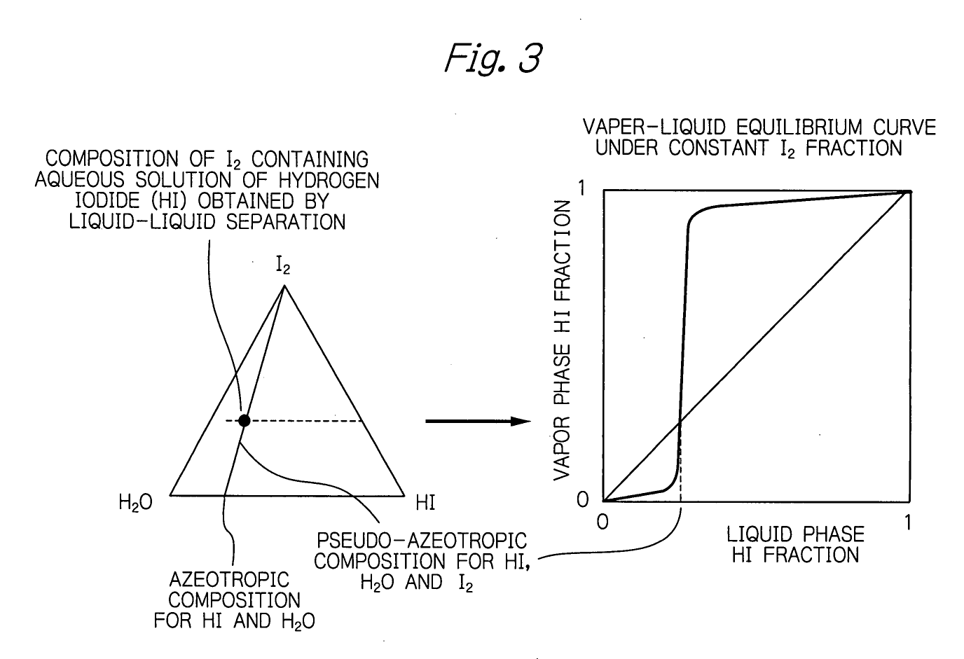

FIG. 4 is a schematic of one reactor that can be used in the present invention;

FIG. 5 is a schematic of another reactor that can be used in the invention;

FIG. 6 is a current vs. voltage plot for varying iodine concentration;

FIG. 7 is a current vs. voltage plot for varying temperature; and

FIG. 8 is a diagram showing the effectiveness of the present invention in terms of the relative hydrogen cost.

### DETASILED DESCRIPTION OF THE INVENTION

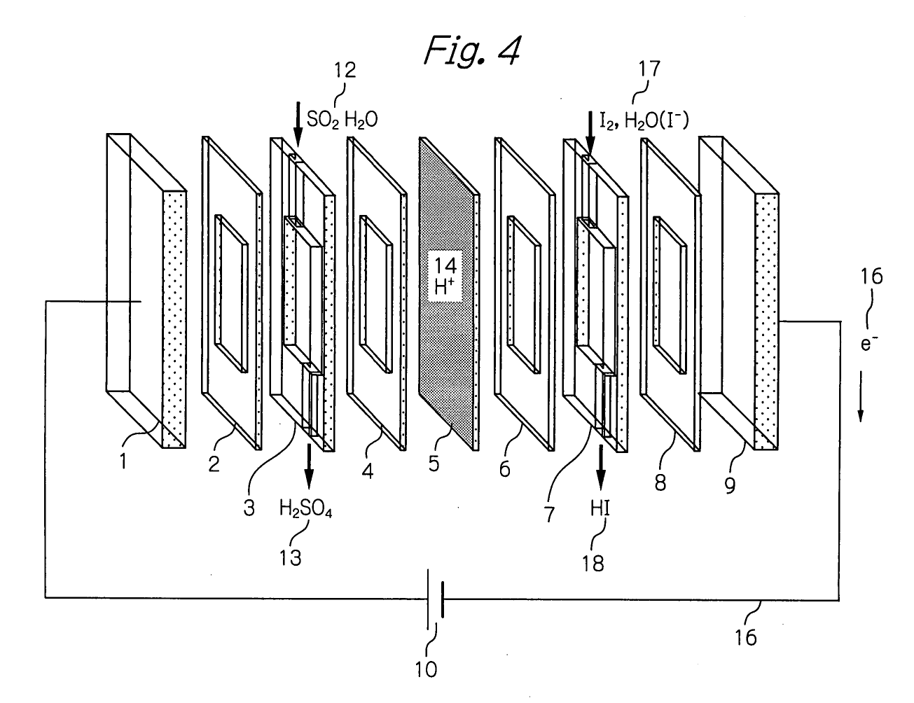

An embodiment of the invention is described below with reference to FIG. 4. The reactor shown in FIG. 4 has a nine-layer structure consisting of a positive electrode 1, a negative electrode 9, a cation exchange membrane 5, spacers 3 and 7, and sealants 2, 4, 6 and 8. The positive electrode 1 and the negative electrode 9 are at opposite ends of the apparatus and stacked between them are the spacer 3, cation exchange membrane 5 and the spacer 7 in that order. The gap between the positive electrode 1 and the spacer 3 is filled with the sealant 2, the gap between the spacer 3 and the cation exchange membrane 5 with the sealant 4, the gap between the cation exchange membrane 5 and the spacer 7 with the sealant 6, and the gap between the spacer 7 and the negative electrode 9 with the sealant 8. All sealants are in sheet form. When voltage is applied between the positive electrode 1 and the negative electrode 9, the associated reactions will start and proceed.

First, an aqueous solution having sulfur dioxide dissolved in water or an aqueous solution having sulfur dioxide dissolved in an aqueous solution of sulfuric acid is fed into the spacer 3 on the positive electrode side. At the positive electrode 1, the reaction of SO₂+2H₂O=H₂SO₄+2H⁺+2e⁻proceeds to produce sulfuric acid 13. Protons permeate the cation exchange membrane 5 to move to the negative electrode 9 whereas electrons pass through the external circuit to migrate to the negative electrode 9. At the negative electrode 9, the reaction of I₂+2e⁻=2I⁻ proceeds. The protons permeating the cation exchange membrane 5 combine with the iodide ions to make hydrogen iodide 18 as the desired intermediate product.

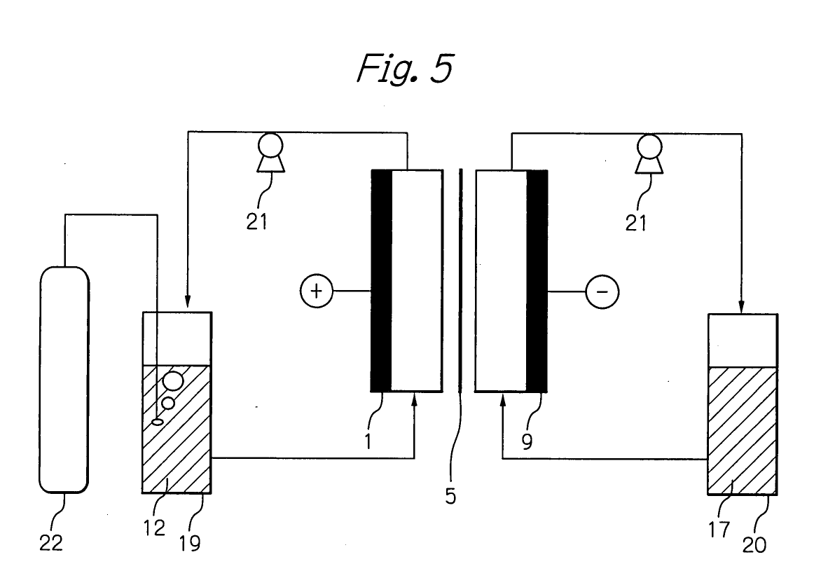

Reference is now made to FIG. 5. The cation exchange membrane was made of Nafion (Du Pont); the positive electrode 1 and the negative electrode 9 were each a carbon electrode; a flask 19 on the positive electrode side was supplied with an aqueous solution of sulfuric acid 12 which contained a specified concentration of sulfur dioxide, and a flask 20 on the negative electrode side was supplied with an aqueous solution of hydrogen iodide 17 which also contained a specified concentration of iodine. Sulfur dioxide was supplied from a gas container 22. Two peristaltic pumps 21 were used in order that the aqueous solution of sulfuric acid 12 also containing sulfur dioxide and the aqueous solution of hydrogen iodide also containing iodine were flowed to the positive electrode 1 and the negative electrode 17, respectively, as a constant current was passed for a specified period to perform the intended reaction. The reaction temperature was controlled with an external heater.

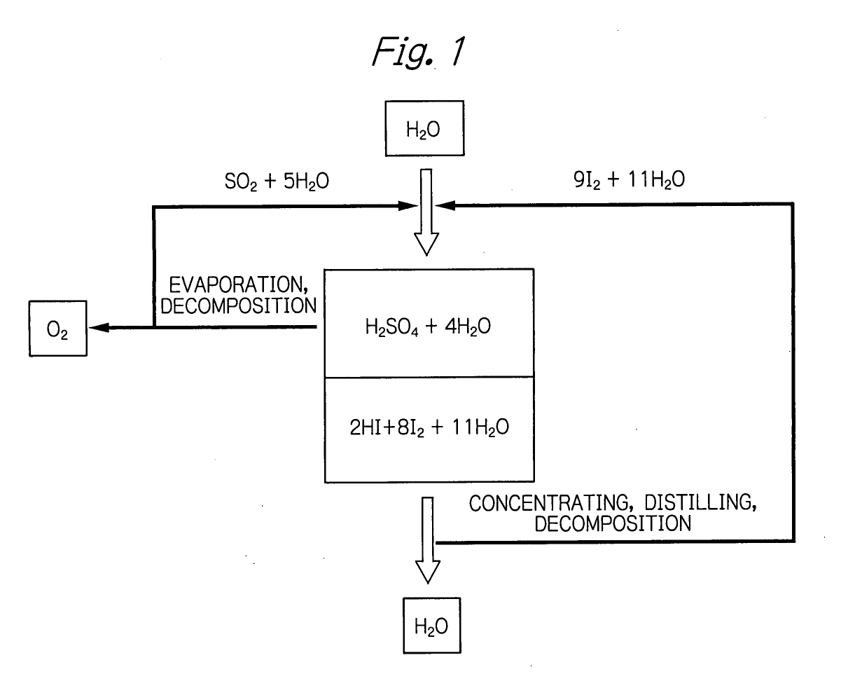

At a temperature of 290 K, the aqueous solution containing each of HI and iodine at a concentration of 3.1 mol/Kg-H₂O (for easy comparison on FIG. 1, the composition of this aqueous solution may be expressed in moles as 2HI+I₂+36H₂O) and the aqueous solution containing H₂SO₄ at a concentration of 3.7 mol/Kg-H₂O were allowed to react under passage of current, whereupon the concentration of hydrogen iodide could be increased to 3.8 mol/Kg-H₂O and that of sulfuric acid to 4.5 mol/Kg-H₂O, showing that hydrogen iodide and sulfuric acid could be concentrated under low iodine condition. The same experiment was conducted with the iodine concentration lowered to 0.2 mol/Kg-H₂O, less than 2% of the previously reported values and still it was possible to concentrate hydrogen iodide by the method of the invention.

In the next place, reaction was carried out under the passage of current at a temperature of 290 K, with the compositions of the aqueous solution of sulfuric acid and the aqueous solution of hydrogen iodide plus iodine being adjusted to the highest levels that could be achieved by the conventional liquid-liquid separation method shown in FIG. 1, except that only the concentration of iodine in the second aqueous solution was reduced to a quarter (the first aqueous solution consisting of H₂SO₄+4H₂O; the second aqueous solution consisting of 2HI+2I₂+11H₂O). The composition of the second aqueous solution was substantially pseudo-azeotropic. As a result of a continuity test, the solution on the positive electrode side was found to have the composition of H₂SO₄+3.8H₂O in terms of molar ratio whereas the solution on the negative electrode side was found to have the composition of 2HI+2I₂+10.4H₂O, also in terms of molar ratio. Since these molar ratios were higher than those reported in Gas Research Institute, GRI-80/0105 (1981), it was shown that an aqueous solution containing more hydrogen iodide than at the pseudo-azeotropic composition could be obtained in separate form from an aqueous solution with high concentration of sulfuric acid.

### EXAMPLE

The method of the invention was implemented using Nafion of Du Pont as a cation exchange membrane. A carbon electrode was used as both the positive and negative electrodes. Kalrez (Du Pont) was used as a sealant. Two flasks each having a capacity of 200 ml were provided and one of them was supplied with an aqueous solution containing sulfuric acid at a specified concentration under bubbling of sulfur dioxide gas. The other flask was supplied with an aqueous solution containing hydrogen iodide and iodine at specified concentrations. Using rotary pumps, the two aqueous solutions were flowed to the positive and negative electrodes. A constant current was flowed for a specified period to get the reaction to proceed. The reaction temperature was controlled by heating the system with an external heater and measuring the temperature of the reaction solution at the exit. The concentrations of the respective solutions were measured by titration.

First, a review was made of the decrease in iodine content which is the characterizing part of claim 1. The experiment was conducted at a temperature of 290 K, with the HI content being fixed at 3.1 mol kg-_{H2O}⁻¹. The iodine content was varied between 0.2 and 3.1 mol kg-_{H2O}⁻¹. For easy comparison on FIG. 1, the composition of the reaction system may be expressed as 2HI+(0.13−2)I₂+36H₂O in terms of molar ratio. Under the selected conditions, the amount of iodine recycled for evolving 1 mol of hydrogen was reduced from 2030 g to a minimum of 33 g.

The concentration of sulfuric acid was fixed at 3.7 mol kg-_{H2O}⁻¹. With the iodine content held at 3.1 mol kg-_{H2O}⁻¹, reaction was performed at 0.3 A for 4 hours, whereupon the concentration of hydrogen iodide rose to 3.8 mol kg-_{H2O}⁻¹ and the concentration of sulfuric acid to 4.5 mol kg-_{H2O}⁻¹. It was therefore demonstrated that even under the low iodine condition proposed by the invention, hydrogen iodide and sulfuric acid could be concentrated as the desired intermediate products. The selected concentrations are also reasonable in view of power consumption.

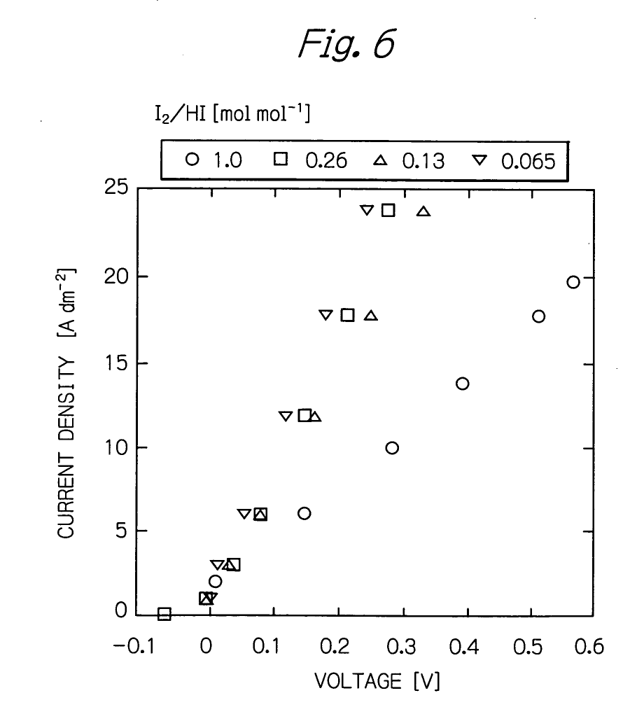

FIG. 6 is a current vs. voltage plot for varying iodine concentration. Obviously, lower voltage was required in the range of smaller iodine concentrations. It was shown that even in the range where the iodine concentration was 0.2 mol kg-_{H2O}⁻¹ which was less than 2% of the previously reported values, hydrogen iodide could be concentrated by the method of the invention. It was also shown that lowering the iodine content contributed to reducing not only the amounts of recyclables but also power consumption, thus proving effective in realizing efficient process operation.

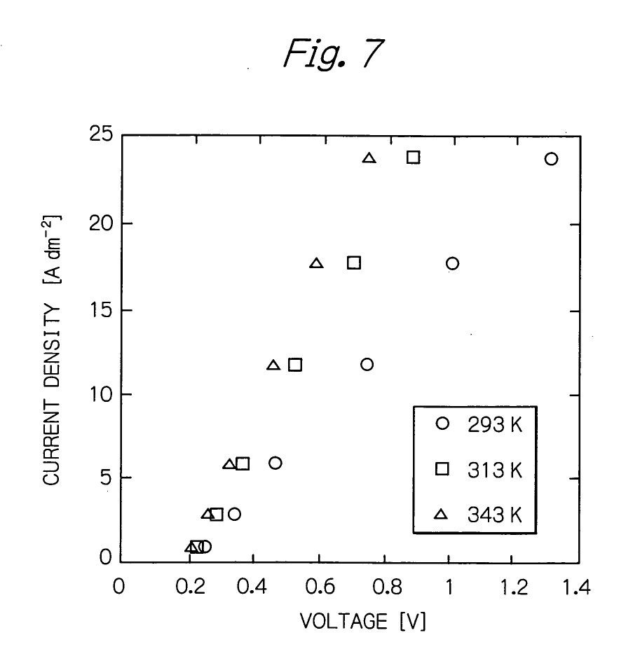

Next, a review was made of the enhancements of the concentrations of hydrogen iodide and sulfuric acid which are the characterizing portions of claims 2 and 3, respectively. The initial concentration of an aqueous solution of sulfuric acid was (H₂SO₄+4H₂O) which is typical in the conventional liquid-liquid separation process, whereas the initial concentration of an aqueous solution of hydrogen iodide was (2HI+2I₂+11H₂O) which, in terms of the iodine content, was a quarter of the value indicated in FIG. 1. The concentration of hydrogen iodide was substantially at the pseudo-azeotropic composition. It then follows that all conditions of claims 1-3 are satisfied if the above-mentioned two aqueous solutions are successfully concentrated. After the 4-hr reaction at 290 K and 0.3 A, the two aqueous solutions had the respective molar ratios of (H₂SO₄+3.8H₂O) and (2HI+2I₂+10.4H₂O), demonstrating that the amounts of water and iodine could be made smaller than the ranges shown in Gas Research Institute, GRI-80/0105 (1981). FIG. 7 is a current vs. voltage plot for varying temperature at the decreased iodine content. Obviously, the voltage requirement was significantly lowered by elevating the operating temperature from 293 K to 313 K.

### INDUSTRIAL APPLICABILITY

Based on the results of the example, the inventors assessed how much of the cost for the production of hydrogen as the final product would be affected by the decrease in the amount of recycling iodine. The two solutions of interest that needed to be separated had the respective compositions of (H₂SO₄+4H₂O) and (2HI+8I₂+11H₂O). The heat source for decomposing sulfuric acid had a power of 200 MW to give a temperature of 1123 K and hydrogen was produced in an amount of 23900 Nm³h⁻¹. By calculating the Heat/Mass balance of the overall process, the sizes of various apparatuses were approximated to assess the overall equipment cost. For vaporizing sulfuric acid, four-stage distillation columns of the type described in Proc. 5th World Hydrogen Energy Conf., p. 487-502 (1984), Pargamon Press were employed. For concentrating hydrogen iodide, an electric dialyzer of the type described in J. Membr. Sci., vol. 192, p. 193-199 (2001), Elsevier was employed, and for decomposing hydrogen iodide, a hydrogen permselective membrane reactor of the type described in J. Membr. Sci., vol. 162, nos. 1-2, p. 83-90 (1999), Elsevier was employed.

The cost for hydrogen production was broken down into the fixed cost, ROI (return on investment), electricity, cooling water, heat and chemicals. The fixed cost and ROI were assumed to account for 25% and 8%, respectively, of the construction cost. The prices of heat and electricity were assumed to be 2.29×10⁻³ yen per kcal and 9.0 yen per kWh, respectively.

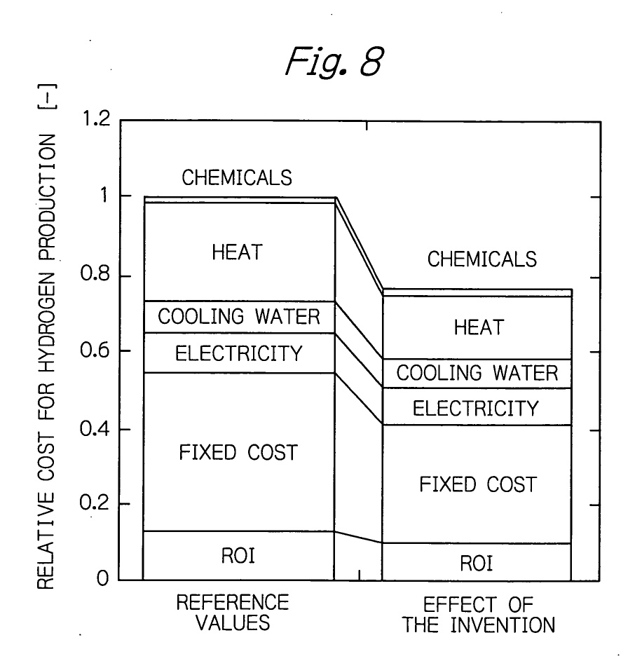

By this method, the price of hydrogen was first computed, then the effectiveness of the present invention was assessed. In the example, the amount of recycling iodine was reduced to less than 2% of the previously reported values, so the amount of recycling iodine was ignored in assessing the sizes of various apparatuses. The results are shown in FIG. 8. Obviously, the decrease in the amounts of recyclables contributed to a 20% decrease in the overall equipment volume. As a result, both of the fixed cost and ROI decreased by 20% compared to the reference values. In addition, the decrease in the amount of circulation contributed to reduction in the costs of cooling water and heat. Overall, the cost reduction was 23%.

1. A process for producing hydrogen by the intense thermal energy from thermochemical water splitting using iodine and sulfur dioxide, wherein an aqueous solution containing iodine as a main component and an aqueous solution containing sulfur dioxide as a main component are reacted across a membrane, thereby reducing the concentration of iodine in the second aqueous solution.

2. A process for producing hydrogen by the intense thermal energy from thermochemical water splitting using iodine and sulfur dioxide, wherein an aqueous solution containing iodine as a main component and an aqueous solution containing sulfur dioxide as a main component are reacted across a membrane, thereby concentrating the second aqueous solution until the concentration of hydroiodic acid in it is higher than the pseudo-azeotropic composition.

3. A process for producing hydrogen by the intense thermal energy from thermochemical water splitting using iodine and sulfur dioxide, wherein an aqueous solution containing iodine as a main component and an aqueous solution containing sulfur dioxide as a main component are reacted across a membrane, thereby concentrating the first aqueous solution until the concentration of sulfuric acid in it is higher than the value reported for the existing liquid-liquid separation method which is H₂SO₄ to 4H₂O in terms of molar ratio.

4. A process for producing hydrogen by the intense thermal energy from thermochemical water splitting using iodine, sulfur dioxide and intense thermal energy, which employs electrode portions and a cation exchange membrane to have sulfur dioxide, iodine and water react with one another and obtain an aqueous solution of hydrogen iodide and an aqueous solution of sulfuric acid in separate form.
